(19) United States
(12) Patent Application Publication
(10) Pub. No.: US 2003/0005166 A1
(43) Pub. Date: Jan. 2, 2003

(54) Tracking component manager

(75) Inventor: Glenn R. Seidman, Woodside, CA (US)

Correspondence Address: MICHAEL B. EINSCHLAG, ESQ., 25680 FERNHILL DRIVE, LOS ALTOS HILLS, CA, 94024, US

(73) Assignee: Verano

(21) Appl. No.: 09/884,505

(22) Filed: Jun. 14, 2001

(51) Int. Cl. G06F 9/00; G06F 9/54; G06F 15/163; G06F 9/46

(52) U.S. Cl. 709/310; 709/328

(57) ABSTRACT

One embodiment of the present invention is a component manager that manages one or more tracking components, the component manager including: a deployer that generates a client interface for each tracking component output port, and deploys the client interface in a directory service, wherein each entry is a tracking point object. In another embodiment, the deployer further generates a client interface for each tracking component input port, and deploys the client interface in a directory service, wherein each entry is a tracking point object.

### TECHNICAL FIELD OF THE INVENTION

The present invention pertains to component managers, components associated with the component managers, and methods and apparatus for fabricating the component managers and their associated components. In particular, the present invention pertains to a tracker component manager (for example, a deferred response component manager embodied as an Enterprise TrackerBean container) and tracker components (for example, tracker components embodied as Enterprise TrackerBeans) associated therewith.

### BACKGROUND OF THE INVENTION

A critical issue in an enterprise computing environment relates to a need to: (a) develop tracking sources that track and monitor status of software subsystems and devices; and (b) aggregate vast quantities of information available from multiple such tracking sources into a meaningful presentation. An additionally issue relates to a need for normal batch processes running in the enterprise computing environment to react to monitored conditions and specific tracking information criteria in real-time.

Typical enterprise computing system deployments comprise many distinct computing subsystems, each of which computing subsystems have distinct purposes and are built by distinct development teams from separate corporations or from separate divisions within a corporation. This typically results in monitoring and tracking clients that: (a) have a distinct look and feel; and (b) address different deployed computing subsystems. As a result, an underlying tracking infrastructure that delivers tracking information from the computing subsystems to the monitoring and tracking clients (using client interfaces) tends to be developed in such a way that a tracking capability is coded for each distinct computing system without an enterprise-wide view. Then, in light of this state of affairs, whenever a new computing subsystem is added to an enterprise computing system, tracking infrastructure code must be developed for the new computing system.

Sun Microsystems has introduced Java Management Extensions (“JMX”) that specifies a unified approach for developing management components—these management components can be used for tracking or configuring. Using JMX, management components can be built across computing subsystems by distinct development teams, and they can be brought together in a coherent manner to use or build client interfaces having a same look and feel. Although JMX assists in constructing management components, it does not help two or more management components work together to track or monitor together to accomplish a larger tracking task (i.e., JMX mostly expects management components to provide tracking and configuration in isolation). Thus, to get management components to work together, more code must be developed.

In light of the above, there is a need for method and apparatus that enables tracking components to be developed, and that provides a mechanism for these tracking components to work together in tracking networks without additional code development.

### SUMMARY OF THE INVENTION

Embodiments of the present invention advantageously satisfy the above-identified need in the art and provide methods and apparatus that enable tracking components to be developed, and that provides a mechanism for these tracking components to work together in tracking networks without additional code development. In addition, advantageously, at least some embodiments of the present invention are compatible with JMX. In particular, one embodiment of the present invention represents a tracking component manager (embodied, for example, as a container) that provides freely gained characteristics for very large scale tracking and monitoring tracking by associating components with the tracking component manager (for example, by dropping the component into the container)—along with simple text declarations, representing tracking instructions for each component (for example, set forth in a deployment descriptor). In particular, in accordance with one embodiment of the present invention, a tracking component manager that is fabricated in accordance with one embodiment of the present invention provides a client user interface that makes it easy to: (a) configure individual tracking components; (b) track individual tracking components; and (c) connect tracking components into a tracking network to provide aggregate tracking information.

Specifically, one embodiment of the present invention is a component manager that manages one or more tracking components, the component manager comprising: a deployer that generates a client interface for each tracking component output port, and deploys the client interface in a directory service, wherein each entry is a tracking point object. In another embodiment, the deployer further generates a client interface for each tracking component input port, and deploys the client interface in a directory service, wherein each entry is a tracking point object.

### BRIEF DESCRIPTION OF THE FIGURE

FIG. 1 shows symbols used in the Detailed Description to describe various software entities and their interrelationships;

FIG. 2 shows various of the interrelationships shown in FIG. 1;

FIG. 3 shows a component deployment file;

FIG. 4 shows a block diagram of tracking component instances disposed in an Enterprise TrackerBean Container along with their associated TrackingPoint objects for their input and output ports;

FIG. 5 shows a block diagram of a TrackerBean Object Model that illustrates an input and output port paradigm;

FIG. 6 shows a block diagram of TrackerBeans deployed in distributed ETB Containers wherein information flows are identified for different connection types;

FIG. 7 shows a TrackerBean configurator user interface that displays a source of tracking information for TrackerBean named “Ross”;

FIG. 8 shows a block diagram of an internal subsystem architecture for an Enterprise TrackerBean Container that is fabricated in accordance with the present invention;

FIG. 9 shows a block diagram of an XML grammar structure of a TrackerBean deployment descriptor that is fabricated in accordance with the present invention;

FIG. 10 shows a block diagram of an XML grammar structure of a tracking point network descriptor that is fabricated in accordance with the present invention;

FIG. 11 shows a block diagram of an architecture of a TrackerBean TreeNode that is stored within a TrackerBeans dictionary shown in FIG. 8; and

FIG. 12 shows a block diagram of an interaction between an architecture of a TrackerBean TreeNode that is stored in a TrackerBeans dictionary and an architecture of a TrackerPointNetwork that is stored in a TrackerPointNetworks dictionary.

### DETAILED DESCRIPTION

In accordance with one embodiment of the present invention, a tracking component manager enables software components developed according to a new design pattern to be deployed, and to enjoy advantages for very large scale tracking and monitoring without having to explicitly code to gain such advantages. In accordance with one or more embodiments of the present invention, the advantageously obtained advantages include transparent and automated scheduling and synchronization of tracking information flows and automated creation of tracking points. In addition, in accordance with one or more embodiments of the present invention, a tracking component manager also provides a client user interface that makes it easy to configure individual components, track individual components, and connect tracking components into a tracking network to provide aggregate tracking information.

In accordance with one embodiment of the present invention, an Enterprise TrackerBean Container (“ETB” Container) operates on a network server with client systems requiring tracking on the same server. Further embodiments of the present invention cover situations where client systems reside in a distinct server. When the client systems reside in the same network server as the ETB Container, the client systems may access the ETB Container in their same process or a distinct process.

An ETB Container fabricated in accordance with one embodiment of the present invention provides a component manager in the form of a container architecture wherein components, for example, tracking components may be deployed into the container to gain beneficial dynamics and services. In accordance with one embodiment of the present invention, contracts (for example: a container/component contract; a client/component contract; and a deployment contract) are specified by way of interfaces (the interfaces include an administrative user interface) and a deployment model. The following lists benefits provided by one or more embodiments of the present invention: (a) a unified component object model for tracking and analyzing data from information sources; (b) a framework for configuring tracking components; (c) automated scheduled and synchronized processing of tracking information; (d) automated creation of tracking points; (e) a connection framework to establish a network of tracking points across local and distributed containers; (f) aggregation of components to form larger, composite components; (g) data flow management between tracking point inputs and outputs; (h) a listening framework for external client components; and (i) automatic registration of the components into a naming directory.

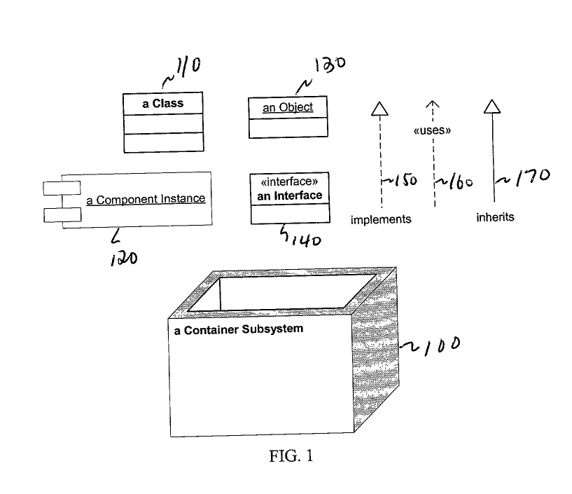

The following detailed description of embodiments of the present invention employs UML structure diagrams that are well known to those of ordinary skill in the art to describe various software entities and their relationships and to aid in understanding the present invention. Note, however, that the container subsystem symbol shown, for example, in FIG. 1, is not an UML standard, but it is used to better illustrate that some embodiments of the present invention comprise a container that “contains” components that get deployed thereinto.

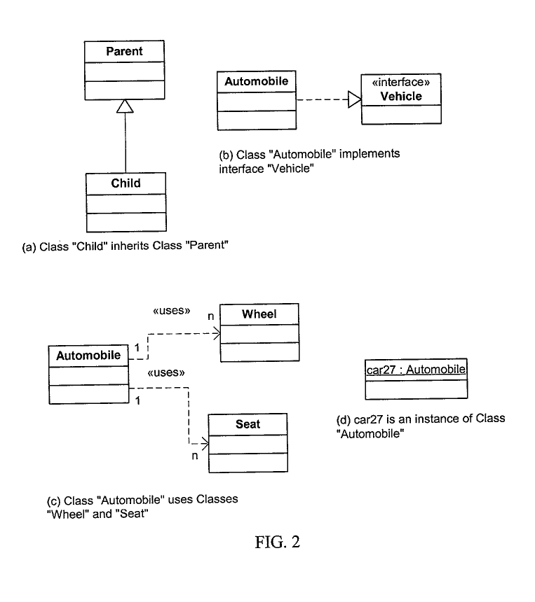

FIG. 1 shows the symbols used herein to describe various software entities and their interrelationships. As shown in FIG. 1, symbol 100 refers to a container subsystem, symbol 110 refers to a class, symbol 120 refers to a component instance, symbol 130 refers to an object, symbol 140 refers to an interface, symbol 150 refers to an interrelationship of “implements,”, symbol 160 refers to an interrelationship of “uses,” and symbol 170 refers to an interrelationship of “inherits.” FIG. 2 shows various of the interrelationships shown in FIG. 1. As shown in FIG. 2a, the class “child” inherits class “Parent.” As further shown in FIG. 2b, class “Automobile” implements interface “Vehicle.” As still further shown in FIG. 2c, class “Automobile” uses classes “Wheel” and “Seat.” Lastly, as further shown in FIG. 2d, car 27 is an instance of class “Automobile.”

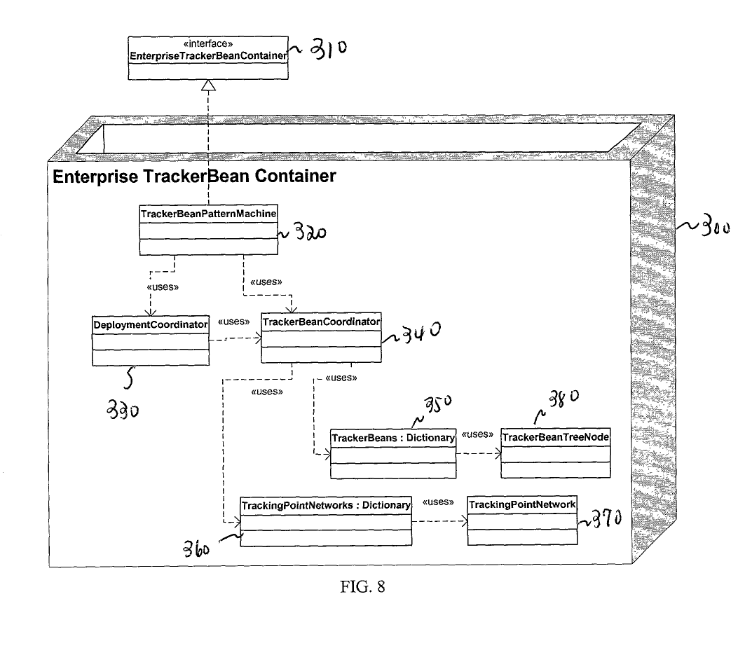

FIG. 8 shows a block diagram of software subsystems (along with their interrelationships) that comprise one embodiment of the present invention. In accordance with this embodiment of the present invention, Enterprise TrackerBean Container 300 manages Enterprise TrackerBeans (not shown in FIG. 8), and a single interface (Enterprise TrackerBeanContainer interface 310) through which requests are made. As shown in FIG. 8, TrackerBeanPattemMachine 320 is the sole implementer of the single Enterprise TrackerBeanContainer interface 310 (i.e., the TrackerBeanPatternMachine class provides EnterpriseTrackerBeanContainer interface 310 that clients can use to access TrackerBeans and tracking points deployed inside Enterprise TrackerBean Container 300). Further, TrackerBeanPatternMachine 320 maintains responsibility to manage the life cycle of Enterprise TrackerBeans. In accordance with one embodiment of the present invention, embodiments of the inventive systems operate by implementing the following: (a) a component manager/component contract; (b) a client/container contract; and (c) a deployment contract.

As shown in FIG. 8, DeploymentCoordinator 330 drives a deployment system while TrackerBeanPatternMachine 320 drives client runtime. Together, DeploymentCoordinator 330 and TrackerBeanPatternMachine 320 initiate processing that may be declared using a deployment descriptor. TrackerBeanPatternMachine 320 also manages several administrative functions through its EnterpriseTrackerBeanContainer interface 310. For example, using EnterpriseTrackerBeanContainer interface 310, TrackerBeanPatternMachine 320 causes the entire Enterprise TrackerBean Container 300 to be: (a) started; (b) shutdown; (c) queried for currently deployed DeferredResponse components; (d) requested to deploy additional component deployment files into the container; and (e) queried for historic occurrences (i.e., to provide an audit trail of various types) in accordance with methods that are well known to those of ordinary skill in the art.

In accordance with this embodiment of the present invention, DeploymentCoordinator 330 handles deployment of new TrackerBeans and tracking point networks. DeploymentCoordinator 330 uses TrackerBeanCoordinator 340 to store the deployed information. TrackerBeanCoordinator 340 also coordinates runtime actions of the TrackerBeans and the tracking points in a manner to be described in detail below. TrackerBeanCoordinator 340 uses two dictionaries, TrackerBeans dictionary 150 and TrackingPointNetworks dictionary 360 to store deployed TrackerBeans and tracking point networks, respectively.

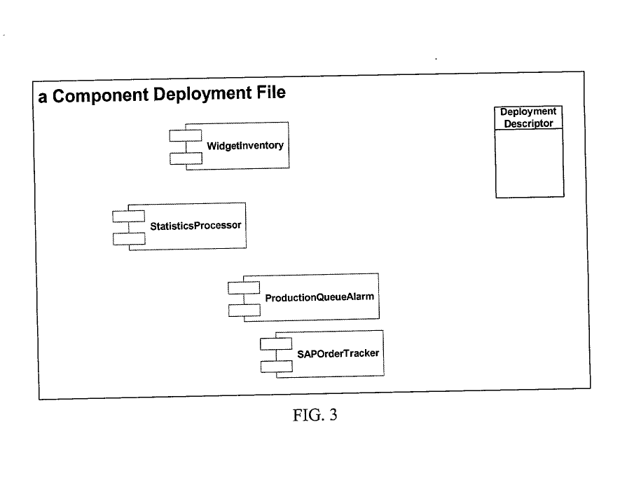

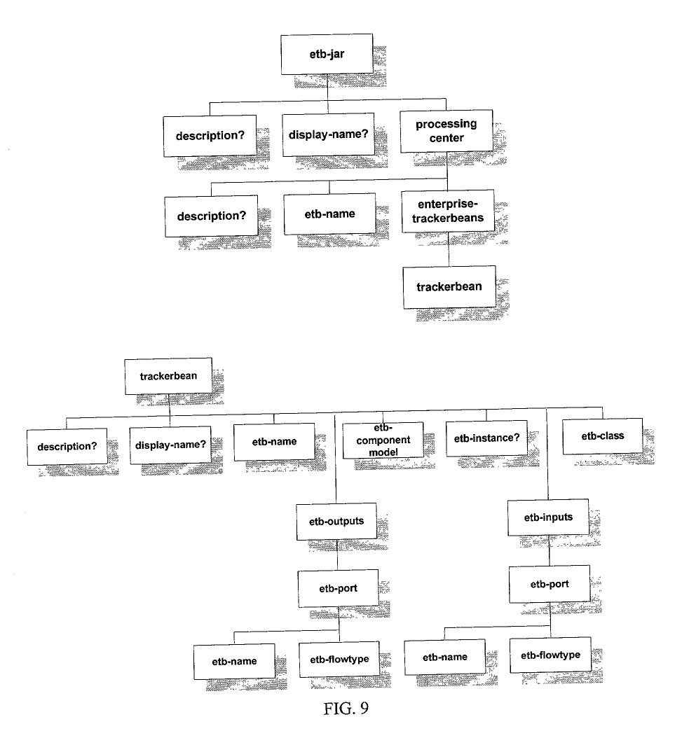

In accordance with this embodiment of the present invention, at run time, DeploymentCoordinator 330 receives deployment files utilizing any one of a number of methods that are well known to those of ordinary skill in the art. As will be described in detail below, a deployment file comprises one or more tracking components along with a deployment descriptor text file (see FIG. 3) that gives declarative instructions to ETB Container 300 for each component. For example, and without limitation, DeploymentCoordinator 330 can poll a predetermined subdirectory of Enterprise TrackerBean Container 300 for the presence of new deployment files; or DeploymentCoordinator 330 can be invoked directly by way of an Enterprise JavaBean SessionBean that represents DeploymentCoordinator 330 in accordance with methods that are well known to those of ordinary skill in the art; or a new deployment file may be handed to TrackerBeanPatternMachine 320 using its EnterpriseTrackerBeanContainer interface 310. Whenever DeploymentCoordinator 330 detects a new TrackerBean deployment file, it reads each of the components in the deployment file, along with the component's associated deployment descriptors. In accordance with this embodiment of the present invention, the components read by DeploymentCoordinator 330 may either be a class or a serialized component instance. However, whenever the component read is a class, the class is instantiated in accordance with methods that are well known to those of ordinary skill in the art. In accordance with one embodiment of the present invention, a deployment descriptor for a TrackerBean is an XML file that comprises elements that describe the name and type of the TrackerBean. The file also lists details of input and output ports of the TrackerBean. FIG. 9 shows a block diagram of an XML grammar structure of a TrackerBean deployment descriptor that is fabricated in accordance with the present invention. Based on the information provided in the TrackerBean deployment descriptor, DeploymentCoordinator 330 creates the component in accordance with any one of a number of methods that are well known to those of ordinary skill in the art, and uses TrackerBeanCoordinator 340 to add it to TrackerBeans dictionary 350 contained inside TrackerBeanCoordinator 340 in accordance with any one of a number of methods that are well known to those of ordinary skill in the art.

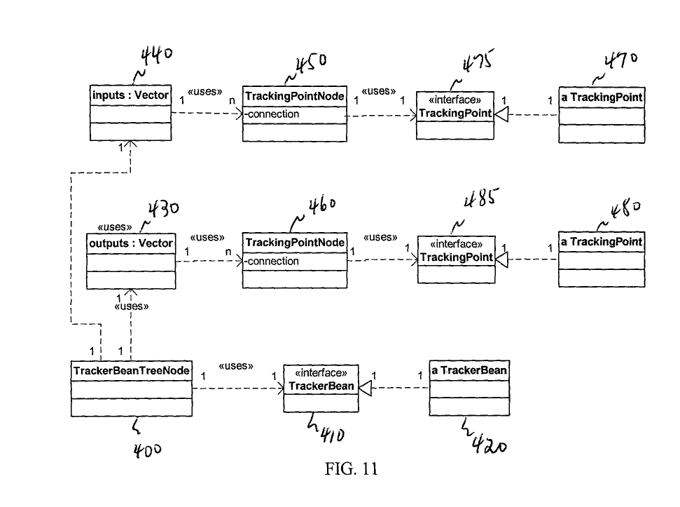

FIG. 11 shows a block diagram of an architecture of TrackerBeanTreeNode 380 that is stored within TrackerBeans dictionary 350 shown in FIG. 8. The nodes shown in FIG. 11, contain information about deployed a TrackerBean and its input and output ports. For example, in accordance with the embodiment shown in FIG. 11, each TrackerBeanTreeNode object (for example, TrackerBeanTreeNode object 400) comprises: (a) a TrackerBean object (for example, TrackerBean object ) to which it refers through an interface (for example, TrackerBean interface 410); (b) an inputs vector (for example, inputs vector 440) which comprises information regarding all of the referred TrackerBean's input ports; and (c) an outputs vector (for example, outputs vector 430) which comprises information regarding all of the referred TrackerBean's output ports. In accordance with one embodiment of the present invention, each input and output port of a TrackerBean that is described in the tracker bean deployment descriptor is instantiated as a TrackingPointNode object (for example, TrackingPointNode object 450 and TrackingPointNode object 460, respectively), and added to the input and output vectors (for example, inputs vector 440 and outputs vector 430) in accordance with any one of a number of methods that are well known to those of ordinary skill in the art. In accordance with this embodiment of the present invention, a TrackingPointNode object (for example, TrackingPointNode object 450 or TrackingPointNode object 460) comprises an instance of an object that conforms to a TrackingPoint interface (for example, TrackingPoint interface 475 or TrackingPoint interface 485); an embodiment of a TrackingPoint interface will be described in detail below. In addition, the TackingPointNode object also comprises an empty vector called “connections” at creation time. In accordance with this embodiment, this vector is used to store all connections for a given tracking point by DeploymentCoordinator 330 after it reads the tracking point network deployment descriptor.

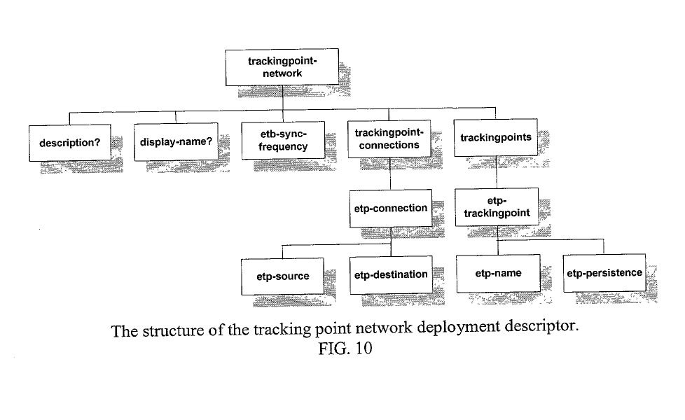

Whenever DeploymentCoordinator 330 detects a new TrackingPointNetwork deployment file, it reads the network deployment file, and it creates a TrackingPointNetwork object (for example, TrackingPointNetwork object 370) in accordance with any one of a number of methods that are well known to those of ordinary skill in the art. DeploymentCoordinator 330 uses TrackerBeanCoordinator 340 to add the TrackingPointNetwork object (for example, TrackingPointNetwork object 370) to TrackingPointNetworks dictionary 360 contained inside TrackerBeanCoordinator 340 in accordance with any one of a number of methods that are well known to those of ordinary skill in the art. A deployment descriptor for a tracking point network comprises information about: (a) tracking points in a network; and (b) connections between the tracking points. In addition, the deployment descriptor may also contain a synchronous update frequency for forced connections. FIG. 10 shows a block diagram of an XML grammar structure of a tracking point network deployment descriptor that is fabricated in accordance with the present invention.

In accordance with one embodiment of the present invention, TrackingPointNetworks dictionary 360 comprises all TrackingPointNetwork objects that comprise TrackerBeans from ETB Container 300. In accordance with one embodiment of the present invention, while loading a TrackingPointNetwork deployment descriptor and creating the tracking point network, DeploymentCoordinator 330 checks for correctness of: (a) the network topology; (b) the directional compatibility of connections (for example, in accordance with one embodiment of the present invention, connections start at an output port and end at an input port); and (c) connection types (pull, push or force), which connection types will be described in detail below.

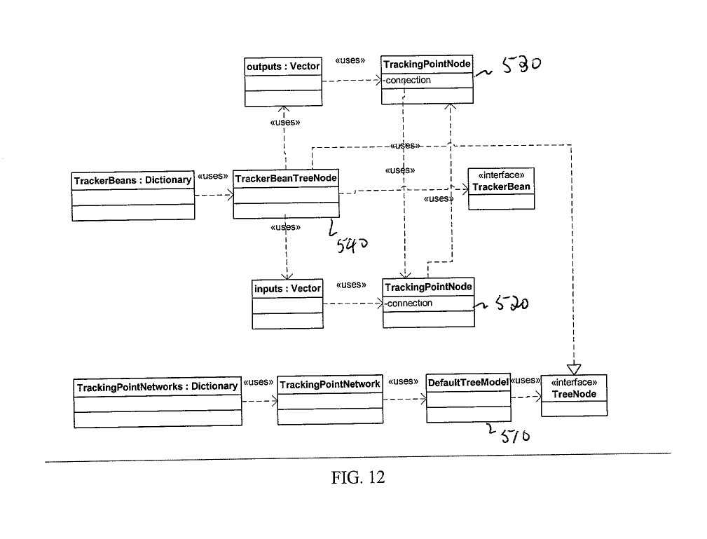

FIG. 12 shows a block diagram of an interaction between an architecture of a TrackerBeanTreeNode (for example, TrackerBeanTreeNode 400 of FIG. 11) that is stored in a TrackerBeans dictionary (for example, TrackerBeans dictionary 350 of FIG. 8) and an architecture of a TrackerPointNetwork (for example, TrackingPointNetwork 370 of FIG. 8) that is stored in a TrackerPointNetworks dictionary (for example, TrackerPointNetworks dictionary 360 of FIG. 8). As shown in FIG. 12, while creating a tracking point network, DeploymentCoordinator 330 stores it using a DefaultTreeModel object (for example, DefaultTreeModel object 510) that uses nodes that conform to JDK's TreeNode interface (for example, TreeNode interface 520). In accordance with this embodiment of the present invention, during the construction of the DefaultTreeModel object, (for example, DefauItTreeModel object 510), DeploymentCoordinator 330 stores connection information for each tracking point in corresponding TrackingPointNode objects (for example, TrackingPointNode objects 520 and 530) contained inside these TrackerBeanTreeNode objects (for example, TrackerBeanTreeNode object 540.

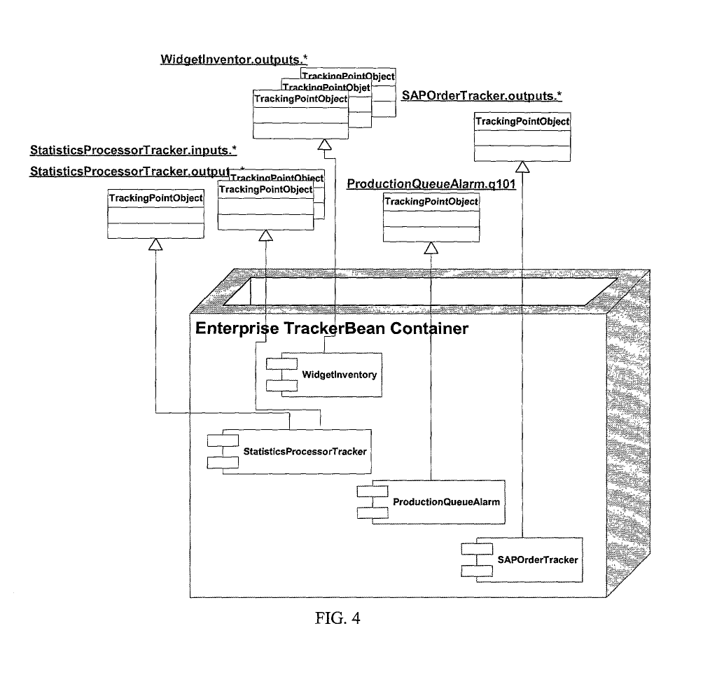

ETB Container 300 does not allow any client to access a deployed tracking component directly. However, ETB Container 300 generates TrackingPoint client interfaces for each input port and output port on the tracking component for a client to use to access the tracking component. In one embodiment of the present invention, ETB Container 300 stores the TrackingPoint client interfaces in a directory service at a location that is accessed using a name assigned to the tracking component in the deployment descriptor concatenated with a name assigned to the input port or the output port in the deployment descriptor. FIG. 4 shows a block diagram of tracking component instances disposed in an Enterprise TrackerBean Container along with their associated TrackingPoint objects for their input and output ports.

Given the above-described architecture and deployment procedure, an embodiment of the present invention, for example, ETB Container 300 obtains all the static information it needs to organize itself, and to process the information in real-time. In accordance with this embodiment of the present invention, during real-time operation, TrackerBeans that track information on other systems synchronously or asynchronously gather information and output it to other TrackerBeans that either display the information in a useful way or do some useful analysis on them. The information flow may happen asynchronously (i.e., initiated by a TrackerBean) or synchronously (i.e., initiated by the ETB Container).

In accordance with this embodiment of the present invention, ETB Container 300 obtains a connection type (connection types will be described in detail below) by calling the issynchronouso method on the start and end tracking points of a connection. Based on boolean answers returned by the tracking points, the connection type can be determined using the following table.

Connection types based on a return value of the
isSynchronous( ) method

| Return value: start point | Return value: end point | Connection type |
|---|---|---|
| True | True | Force |
| True | False | Pull |
| False | True | Push |
| False | False | ERROR |

As one can readily appreciate from the above, if both tracking points return a False reply, the connection type is undefined (an error condition). In accordance with one embodiment of the present invention, DeploymentCoordinator 330 reports such cases as errors. An update frequency for force connections is declared in a TrackingPoint Network deployment descriptor.

In accordance with this embodiment, whenever an asynchronous output occurs, ETB Container 300 synchronously calls the connected input Trackingpoint objects to insert the new data. Similarly, whenever an asynchronous input occurs, ETB Container 300 first synchronously calls the connected output TrackingPoint object for its current Track object. ETB Container 300 can easily process data flow when both the input and output tracking points of a connection are inside it. However, if either one of the tracking points are inside a different container, data flow between them is achieved using EnterpriseTrackerBeanContainer interface 310 which comprises, but is not limited to, a pushTrack( ) and a pullTrack( ) method with signatures set forth below.

void pushTrack(String aTrackingPointName, Track aTrack) throws

RemoteException;

Track pullTrack(String aTrackingPointName) throws RemoteException;

Using the pushTrack( ) and pullTrack( ) methods, an ETB container can push and pull Tracks to another ETB Container to enable necessary data flow in a distributed deployment embodiment of the present invention.

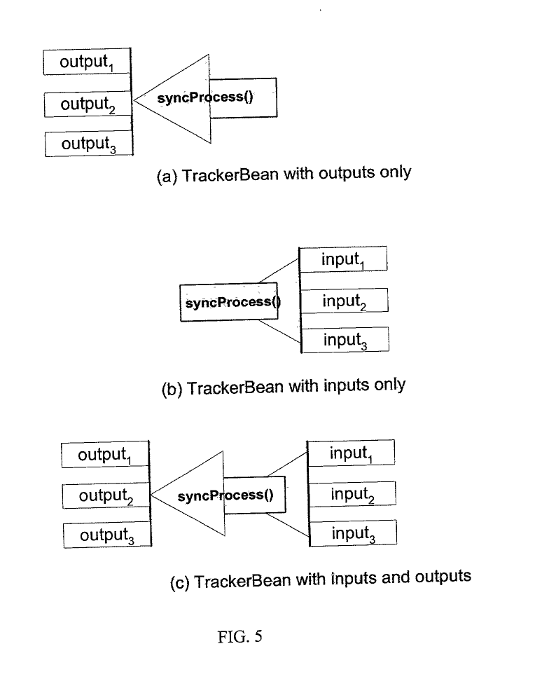

The following describes tracking components that are fabricated in accordance with embodiments of the present invention. FIG. 5 shows a block diagram of a TrackerBean Object Model that illustrates an input and output port paradigm. Each tracking component (for example, embodied as an TrackerBean) must be coded to comply with a TrackerBean interface (to be described in detail below), and must designate input ports and output ports having distinct names. In accordance with one embodiment of the present invention, a tracking component deployed inside an embodiment of a tracking component manager, as shown in FIG. 5, has zero or more input ports and zero or more output ports. In accordance with one embodiment of the present invention, a TrackerBean may monitor an application and provide the monitored information as its output to other TrackerBeans. Such a TrackerBean would have only output ports and no input ports, see FIG. 5a. In accordance with one embodiment of the present invention, a TrackerBean may take outputs from other TrackerBeans and present them as graphs or charts to a user. Such TrackerBeans have only input ports and no output ports, see FIG. 5B. In accordance with one embodiment of the present invention, a TrackerBean may gather outputs of other TrackerBeans and apply mathematical calculations on the acquired information and output the results to other TrackerBeans. Such TrackerBeans have both input and output ports, see FIG. 5c.

Information flows between input ports and output ports of different TrackerBeans. In accordance with some embodiments of the present invention, as described above, the tracking component manager, for example, the ETB Container provides facilities for two modes of information flow between ports, i.e., a synchronous mode of information flow and an asynchronous mode of information flow. In a synchronous mode, the ETB Container may force output by invoking a syncOutputNext( ) call on a TrackerBean. In an asynchronous mode, a TrackerBean may asynchronously make its output available to other components by invoking an asyncOutputNext( ) call on the ETB container.

In accordance with one embodiment of the present invention, the ETB Container uses a syncprocess( ) method to initiate a container-managed schedule for initiating processing on every deployed TrackerBean at a set frequency. The syncProcess( ) method is used for processing outside the immediate scope of data flow. However, such processing may cause an asynchronous data flow. For example, it could be the cause of asynchronous output or input. The method returns a boolean value to let the ETB Container know whether it failed or not (tracking components may ultimately require a connection to external systems, and this connection or other preparatory processing may fail). It is expected that some tracking component output will denote the specifics of the problem. In any case, the ETB Container must know that the syncProcess( ) method processing did not occur correctly.

Tracking component developers must write class code that conforms to a TrackerBean interface.

interface TrackerBean

{

void setTrackerContext(TrackerContext aTrackerContext);

Dictionary getInputDescriptions( );

Dictionary getOutputDescriptions( );

void syncInputNext(String anInputName, Track aTrack);

Track syncOutputNext(String anOutputName);

boolean syncProcess( );

}

In accordance with one embodiment of the present invention, the following interfaces are provided by the ETB Container:

interface Track

{

String getSymbol( );

Integer getQuality( );

Object getData( );

}

interface TrackerContext

{

void asyncOutputNext(String aName, Track aTrack);

Track asyncInputNext(String aName);

}

As set forth above, the TrackerBean interface comprises: (a) methods to access its input and output ports (for example, getInputDescriptions( ), getOutputDescriptions( )); and (b) methods for data flow (for example, syncInputNext( ), syncOutputNext( ), syncprocess( )). In accordance with one embodiment of the present invention, ETB Container 300 uses a method (for example, setTrackerConext( )) to provide a mechanism for a TrackerBean to invoke methods on ETB Container 300. In accordance with this embodiment of the present invention, this information, i.e., which method to invoke, is provided to the TrackerBean, for example, by DeploymentCoordinator 330, when the component, for example, the TrackerBean, is deployed into ETB Container 300. As set forth above, the TrackerContext interface comprises methods that can be used by a TrackerBean to invoke methods on ETB Container 300 to output data asynchronously. Further, the interface Track, set forth above, is an encapsulation of information that is being tracked. Thus, as one can readily appreciate from this, Track objects are primarily data objects associated with a symbol that provide a meaningful name to the data, if necessary. In accordance with other embodiments of the present invention, Tracks may also include quality attributes that provide indications of whether data is stale (for example, quality =0) or not (for example, quality =1).

Component developers may write classes to configure the tracking components that they develop. For example, TrackerBean developers may code TrackerBeans to adhere to any one of the following three configurator interfaces, the last of which one is JMX compliant. It should be understood however, that, although three configurator interfaces are disclosed, embodiments of the present invention are not limited thereto.

interface SimpleConfigurator

{

Dictionary get( );

}

interface ServeletConfigurator

{

java.servlet.Servlet get( );

}

interface <Name of tracking component class>MBean

{

. . . . . . <custom configuration methods >

}

Thus, a deployed tracking component can be configure, among other ways, using any one of the following three types of configurators:

1) SimpleConfigurator: Uses parameter <-> value pairs. When this configurator is used, a web page to enter configuration parameters is automatically generated by ETB Container 300 in accordance with any one of a number of methods that are well known to those of ordinary skill in the art.

2) ServletConfigurator: For example, this uses a Java servlet based configurator.

3) JMX (Java Management Extension Standard) configurators

In accordance with one embodiment of the present invention, at deployment time, ETB Container 300 determines which type of configurator to use for a tracking component that is being deployed. In accordance with one embodiment of the present invention, ETB Container 300 will use the SimpleConfigurator interface first, if it exists, then, it will then a ServletConfigurator interface, and lastly, it will use an MBean interface. As such, an interface with higher priority than the other interfaces will be employed for configuration, while ignoring lower priority configuration interfaces.

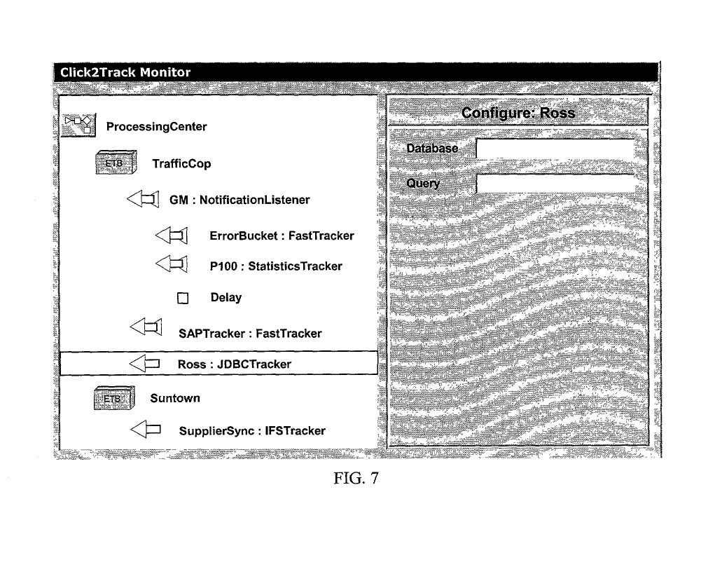

In accordance with one embodiment of the present invention, ETB Container 300 automatically generates a configuration GUI, in accordance with any one of a number of methods that are well known to those of ordinary skill in the art, that can be used to configure individual TrackerBeans based on the configurator interface it finds for a TrackerBean. FIG. 7 shows a TrackerBean configurator user interface that displays a source of tracking information for TrackerBean named “Ross”. In accordance with this embodiment of the present invention, each of the configurator interfaces presents a name-value pair paradigm. As such, ETB Container 300 can generate a web page based on a list of name value pairs in accordance with any one of a number of methods that are well known to those of ordinary skill in the art. In addition, in accordance with one embodiment of the present invention, the ServeletConfigurator interface produces a Servlet that provides a tracking component developer full control over the development of a configuration GUI, if desired.

As was described above, ETB Container 300 generates a tracking point for each input port and each output port of a TrackerBean. Further, in accordance with some embodiments of the present invention, these tracking points are connected to each other to form a network of tracking points. Still further, in accordance with some embodiments of the present invention, each tracking point may have multiple connections. Yet still further, in accordance with some embodiments of the present invention, connections are always directional, i.e., they start at a TrackerBean output port (denoted, for example, as a source) and they end at a TrackerBean input port (denoted, for example, as a destination). In accordance with some embodiments of the present invention, ETB Container 300 advantageously supports tracking point networks of any connection topology (for example, and without limitation, tree, circular, and so forth).

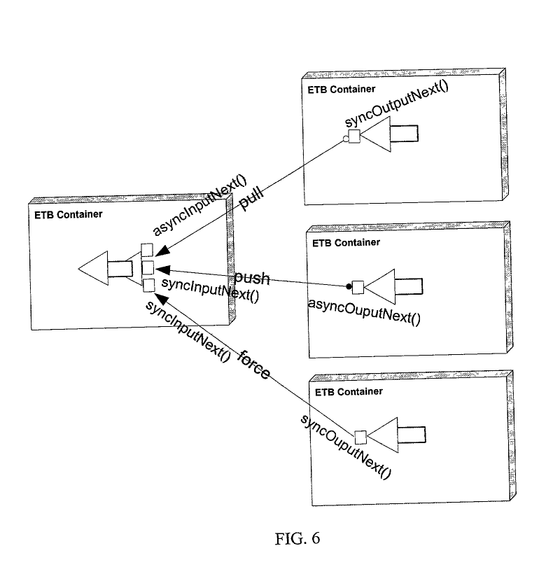

In accordance with one embodiment of the present invention, there are three types of connections: (a) pull; (b) push; and (c) force. Each type of connection operationally involves various combinations of synchronous and asynchronous input and output data flow. The following table shows the operational mechanics of data flow for the above connection types (also refer to FIG. 6 which shows a block diagram of TrackerBeans deployed in distributed ETB Containers wherein information flows are identified for different connection types).

| Connection Type | 1^{st} | 2^{nd} |
|---|---|---|
| Pull | Destination TrackerBean calls | Container calls Source's |
| | TrackerContext.asyncInputNext( ) | TrackerBean.syncOutputNext( ) |
| Push | Source TrackerBean calls | Container calls Destination's |
| | TrackerContext.asyncOutputNext( ) | TrackerBean.syncInputNext( ) |
| Force | Container calls Source's | Container calls Destination's |
| | TrackerBean.syncOutputNext( ) | TrackerBean.syncInputNext( ) |

In accordance with one embodiment of the present invention, a synchronous update frequency of the Force connection type is specified during deployment of a tracking point network.

Clients interested in tracking information can do so by using tracking point objects. In accordance with one embodiment of the present invention, tracking point objects are accessible through an interface known as TrackingPoint. Each TrackingPoint represents one input port or one output port of a TrackerBean. In accordance with one embodiment of the present invention, ETB Container 300 automatically creates and stores these tracking point interface instances, for example, inside a directory service in accordance with any one of a number of methods that are well known to those of ordinary skill in the art. Clients can then access a TrackingPoint, using a name of the TrackingPoint, from the directory service, without actually knowing which container contains the TrackingPoint. In accordance with one embodiment of the present invention, ETB Container 300 stores a state of tracking points inside a persistent store, if requested by a TrackerBean component at deployment time. Further, in accordance with one embodiment of the present invention, a client can register with a TrackingPoint to be notified asynchronously if its data changes. This is done using TrackingPoint and TrackingPointListener interfaces. These interfaces are set forth below.

interface TrackingPointObject

{

void addTrackingPointListener(TrackingPointListener aListener);

Track syncTrackNext( );

boolean isSynchronous( );

}

interface TrackingPointListener extends EventListener

{

void asyncTrackNext(Track aTrack);

}

The method isSynchronous( ) indicates whether the tracking point supports a synchronous mode of data flow. If the tracking point supports a synchronous mode of data flow, a client can read a value inside a tracking point by invoking the syncTrackNext( ) method. If the tracking point supports an asynchronous mode of data flow, a client can

register itself to receive the asynchronous notification using the addTrackingPointListener( ) method. Whenever the tracking point data gets updated, ETB Container 300 will notify the client of the change using the client's asyncTrackNext( ) method.

The following describes the deployment of Enterprise TrackerBeans. In accordance with one embodiment of the present invention, one or more tracking components are packed into a single file, along with a deployment descriptor text file that provides declarative instructions for each component to the container. This file is deployed into the container in the manner described above. However, as was described above, in accordance with one embodiment of the present invention, some tracking components may be specified to represent a tracking point network. In this case, for example, the deployment descriptor would comprise tracking point names and a description of paired connections, each with a source tracking point name and destination tracking point name.

When tracking components have been coded, they are ready for deployment. In accordance with one embodiment of the present invention, in order to deploy one or more tracking components at the same time, their executable file forms are put into a single file such as a ZIP file or other file format that is able to maintain an internal directory structure and store one or more embedded files. Each tracking component may reside anywhere in the internal directory structure, and components may be grouped into the same or multiple deployment files for organizational purposes. An example of a component deployment file is shown in FIG. 3. Also shown in FIG. 3 is a text file known as a deployment descriptor that is located, for example, and without limitation, in an internal directory “META-INF”. The deployment descriptor provides deployment configuration instructions to the container for each tracking component. In accordance with a preferred embodiment of the present invention, XML is used to declare such deployment instructions. Specifically, deployment instructions for each tracking component comprises: a string designating a directory name for the component (for example, its JNDI name); a string designating an internal deployment file path name to a file containing executable code for the component; a string designating an internal deployment file path name to a serialized state of an instance; a string designating a name of the component model (for example, Java, Microsoft COM, CORBA, or any other component models); an integer designating a maximum number of threads that the ETB Container will construct for the component, strings designating names of methods to be made available for tracking; additional strings per method declaring names of parameters; additional strings per method declaring names of two or more outputs for cases where there is more than one output; and additional strings specifying a parameter, a parameter class.

In accordance with one embodiment of the present invention, Enterprise TrackerBeans may be stored in Enterprise TrackerBean JAR files also referred to herein as “ETB JAR” files (the configuration of the Enterprise TrackerBeans described by an ETB Deployment Descriptor is also included within the ETB JAR file). Advantageously, this embodiment enables Enterprise TrackerBeans to be saved, and then deployed at any time.

The following describes ETB JAR Resource files. In accordance with one embodiment of the present invention, there are three categories of resource files: (a) category 1 relates to support files (for example, external native programs or configuration files); (b) category 2 relates to JNI native libraries (for example, dll or so files); and (c) category 3 relates to class and java files.

Category 1 files are stored in a JAR in a directory that corresponds to the bean name. For example, resources for the bean: t.verano.etb_bean.satellite.SatelliteReceiverBean should be stored in the JAR at resources/t/verano/etb_bean/satellite/SatelliteReceiverBean/. All files and any files in any subdirectories under this location will be extracted to %ETB_HOME%/respository/resources/t/verano/etb_bean/satellite/SatelliteReceiverBean/ where %ETB_HOME% is the directory that the ETB Container was installed.

Category 2 files are stored in a similar location. For the bean t.verano.etb_bean.satellite.SatelliteReceiverBean native libraries should be stored in the JAR at resources/t/verano/etb_bean/satellite/SatelliteReceiverBean/native. All files in this location are extracted to %ETB_HOME%/repository/resources/native/SatelliteReceiverBean/<JAR_DATE>/ where <JAR_DATE> is the date and time the jar was created.

Category 3 files are stored in the JAR normally, and according to the JavaBean specification.

The following describes how files are extracted at deployment time. In accordance with one embodiment of the present invention, resource files will be extracted from a JAR at deployment time or at ETB Container start time. If a resource file already exists, the file will be overwritten if the JAR was created after the last modified date of the file. Thus, if one modifies the file and then starts the ETB Container, the file will not be overwritten, However, if one deploys a newer version of the JAR, the file will be overwritten. At undeployment time (i.e., whenever the JAR is deleted) the resource files will be deleted. In addition, if the deployment descriptor does not include a bean's information, the bean's support files will not be extracted from the JAR file.

In accordance with one embodiment of the present invention, an Enterprise TrackingBean locates its support files at runtime by appending the bean name to a path to the location of a resources directory. For example, in one embodiment of the present invention, a system Java property variable “etb.workarea” is set to the location of the resources directory. For example, %ETB_HOME%/repository/resources.

The following describes the deployment of Enterprise TrackingPoint Networks. In accordance with one embodiment of the present invention, one or more TrackingPoint Networks are described within a single deployment file that provides connection information as well as declarative instructions for each network to ETB Container. This file is deployed into the ETB Container in the manner described above.

When TrackingPoint Networks have been described, they are ready for deployment. In accordance with one embodiment of the present invention, in order to deploy one or more TrackingPoint Networks at the same time, each is put into a single file such as, for example, a ZIP file or any other file format that is able to maintain an internal directory structure and store one or more embedded files. Each Trackingpoint Network may reside only in the META-INF subdirectory, but TrackingPoint Networks may be grouped into the same deployment file, or multiple deployment files, for organizational purposes. An example of a TrackingPoint Network deployment file would be the diagram shown in FIG. 3, except with components removed and potentially multiple deployment descriptors, where there would be one deployment descriptor text file for each TrackingPoint Network. Thus, each TrackingPoint Network deployment file comprises no components, and only one or more deployment descriptor text files in an internal directory “META-INF”.

The deployment descriptor provides connection instructions, as well as deployment configuration instructions, to the ETB Container for each Trackingpoint Network. In accordance with a preferred embodiment of the present invention, XML is used to declare such instructions. The structure of this deployment descriptor is depicted in FIG. 10. Specifically, instructions for each trackingpoint and each trackingpoint connection must be listed. The instructions for each trackingpoint comprise: a string designating a directory name for the trackingpoint (for example, its JNDI name); and a Boolean declaring whether or not the trackingpoint should be persisted. The instructions for each trackingpoint-connection comprise: a string designating a directory name for the source trackingpoint; and a string designating a directory name for the destination trackingpoint.

In accordance with one embodiment of the present invention, Enterprise TrackingPoint Networks may be stored in Enterprise TrackingPoint JAR files also referred to herein as “ETP JAR”. Advantageously, this embodiment enables Enterprise TrackingPoint Networks to be saved, and then deployed at any time.

Those skilled in the art will recognize that the foregoing description has been presented for the sake of illustration and description only. As such, it is not intended to be exhaustive or to limit the invention to the precise form disclosed. For example, although embodiments of the present invention have been described using component managers which comprise Enterprise TrackerBean Containers and using components which comprise Enterprise TrackerBeans, those of ordinary skill in the art should readily appreciate that the present invention is not limited to such embodiments. In fact, it is within the spirit of the present invention to include any embodiment of component managers and components. For example, in some embodiments, deferred response may be any objects that support the execution of one or more associated methods as, for example, in object oriented programming. Further, the terms client, client system, and client subsystem also include terms such as, without limitation, client software system or client software subsystem.

Those skilled in the art will recognize that the foregoing description has been presented for the sake of illustration and description only. As such, it is not intended to be exhaustive or to limit the invention to the precise form disclosed.

What is claimed is:

1. A component manager that manages one or more tracking components, the component manager comprising:
a deployer that generates a client interface for each tracking component output port, and deploys the client interface in a directory service, wherein each entry is a tracking point object.

2. The component manager of claim 1 wherein the deployer further:
generates a client interface for each tracking component input port, and deploys the client interface in a directory service, wherein each entry is a tracking point object.

3. The component manager of claim 2 wherein:
at least one output port is a synchronous output port.

4. The component manager of claim 2 wherein:
at least one output port is an asynchronous output port.

5. The component manager of claim 2 wherein:
at least one input port is a synchronous input port.

6. The component manager of claim 5 wherein:
at least one input port is an asynchronous input port.

7. The component manager of claim 2 wherein a client interface may be interacted with using a distributed communication protocol.

8. The component manager of claim 6 wherein a client interface may be interacted with using a distributed communication protocol.

9. A tracking component that comprises one or more output ports whose data values may be synchronously requested, wherein the data values may be any object type, and wherein a synchronous request for an output data value results in an invocation of a predetermined component method representing the output port that: (a) performs processing to obtain the output data value, or (b) returns an already gathered data value generated by an internal component process.

10. A tracking component that comprises one or more input ports whose data values may be synchronously submitted, wherein the data values may be any object type, and wherein a synchronous request for submitting an input data value results in an invocation of a predetermined component method representing the input port that performs processing to: (a) store, (b) operate upon, or (c) transform a new input value.

11. A tracking component that comprises one or more output ports whose data values may be asynchronously generated by the tracking component and received by a component manager, wherein the data values may be any object type.

12. A tracking component that comprises one or more input ports whose data values may be asynchronously requested from the tracking component by a component manager, wherein the data values may be any object type.

13. The component manager of claim 2 which further comprises:
a manager deployer that deploys one or more of a client interface representing an instance of the component manager, wherein each component manager may drive data to and from tracking components located in remote component manager instances interacting through interfaces of the remote component manager instances using a distributed communication protocol.

14. The component manager of claim 2 further comprises:
a listener connector that registers a client to a tracking point using a predetermined Listener interface; and
a listener responder that invokes a predetermined method on the predetermined Listener interface whenever a new data value is input to the tracking point.

15. The component manager of claim 2 further comprises:
a persister that persistently stores all data values input to a tracking point.

16. The component manager of claim 2 further comprises:
a persister that receives information specifying predetermined data received by the component manager to be stored in persistent non-volatile memory.

17. The component manager of claim 2 further comprises:
an invoker that invokes a predetermined method on a tracking component periodically based on a predetermined time interval.

18. The component manager of claim 2 wherein the deployer further:
reads and deploys a file including component classes in the component manager.

19. The component manager of claim 2 wherein the deployer further:
reads and deploys a file including component instances in the component manager.

20. The component manager of claim 17 wherein the deployer further comprises:
a deployment descriptor interpreter that reads a deployment descriptor included in a file wherein a synchronizing interval may be declared for each tracking component, which synchronizing interval determines the predetermined time interval.

21. The component manager of claim 20 wherein the deployer interpreter further:
reads the deployment descriptor wherein synchronous inputs and outputs and asynchronous inputs and outputs are declared.

22. The component manager of claim 21 wherein the deployer interpreter further:
reads the deployment descriptor wherein a time interval for invoking a predetermined method periodically is specified.

23. The component manager of claim 2 further comprises a software component to operate on components implemented in one of the following component models: JavaBeans, Microsoft COM, and CORBA.

24. The component manager of claim 2 wherein the deployer further:
reads and deploys a file including one or more tracking point deployment descriptors, each of which tracking point deployment descriptors includes a list of tracking point names and a description of paired tracking point connections, each of which paired connections having a source tracking point name and a destination tracking point name; and
matches tracking points generated by output and input ports attached to previously deployed tracking components.

25. The component manager of claim 24 wherein:
at least one output port is a synchronous output port;
at least one input port is a synchronous input port; and
the component manager further comprises a forced data transmitter that periodically synchronously requests data from a source synchronous output port and submits the data obtained to a destination synchronous input port based on a predetermined tracking point connection.

26. The component manager of claim 25 wherein the deployer interpreter further:
reads the deployment descriptor wherein a time interval to transmit forced data periodically is specified.

27. The component manager of claim 24 wherein:
at least one output port is an asynchronous output port;
at least one input port is a synchronous input port; and
the component manager further comprises a push data transmitter that synchronously submits a data value to an input port of a tracking component represented by a predetermined tracking point destination whenever a corresponding predetermined tracking point source is an asynchronous output port that has generated a new data value.

28. The component manager of claim 24 which further comprises:
at least one output port is a asynchronous output port;
at least one input port is an asynchronous input port; and
the component manager further comprises a pull data transmitter that synchronously requests a data value from an output port of a tracking component represented by a predetermined tracking point source whenever a corresponding predetermined tracking point destination is an asynchronous input that has requested a new data value.

29. The component manager of claim 2 further comprises:
a configurator designator that discovers a configurator interface on each tracking component which provides names of configurable attributes that can modify behavior of a tracking component; and
a configurator manager that automatically constructs an executable file that represents an user interface that displays attribute values and receives user input to modify the attribute values.

30. The component manager of claim 29 wherein the configurator manager further displays the generated configuration user interface showing the attribute values.
